(19) United States
(12) Patent Application Publication
(10) Pub. No.: US 2017/0156315 A1
(43) Pub. Date: Jun. 8, 2017

(54) METHODS AND COMPOSITIONS OF GRANULE FORMULATIONS

(71) Applicant: AgroFresh Inc., Collegeville, PA (US)

(72) Inventors: Christian Guy BECKER, King of Prussia, PA (US); Bridget Marie STEVENS, Horsham, PA (US); Mark Linden DAHMER, Ankeny, IA (US)

(21) Appl. No.: 15/437,695

(22) Filed: Feb. 21, 2017

Related U.S. Application Data
(62) Division of application No. 13/974,636, filed on Aug. 23, 2013.
Application No. 13/974,636 is a continuation-in-part of application No. 13/294,575, filed on Nov. 11, 2011, now abandoned.
(60) Provisional application No. 61/845,029, filed on Jul. 11, 2013.
(60) Provisional application No. 61/420,489, filed on Dec. 7, 2010.

(51) Int. Cl. A01N 25/12; A01N 27/00

(52) U.S. Cl. CPC A01N 25/12; A01N 27/00

(57) ABSTRACT

This invention is related to granule formulations of a molecular complex comprising a volatile compound, where no adjuvant/binder is required in such granule formulations. In addition, it is surprising that use of molecular sieve destabilizes the granule formulations provided herein, thus no molecular sieve is required. Provided are methods for preparing granule formulations of a molecular complex comprising a volatile compound, and compositions comprising such granule formulations. In addition, methods of treating plant or plant parts using compositions disclosed herein are also provided.

### CROSS-REFERENCE TO RELATED APPLICATIONS

This application claims priority under 35 U.S.C. §119 of U.S. provisional patent application Ser. No. 61/845,029 filed Jul. 11, 2013, which application is hereby incorporated by reference in its entirety. This application also claims priority as a continuation-in-part of U.S. patent application Ser. No. 13/294,575 filed Nov. 11, 2011, which claims priority of provisional patent application Ser. No. 60/420,489 filed on Dec. 7, 2010; the contents of which are hereby incorporated by reference in their entireties.

### BACKGROUND OF THE INVENTION

It is sometimes desired to use a cyclopropene compound to enhance the growth of crop plants. US patent publication 2007/0165166 discloses methods involving contacting crop plants with compositions that contain a cyclopropene compound. In the examples of US 2007/0165166, that contacting is conducted by spraying a liquid composition onto the plants. There are drawbacks associated with using liquid compositions containing cyclopropene compound. Liquid compositions require special equipment, such as, for example, equipment for spraying, and such equipment is sometimes not available. Also, liquid compositions are usually stored in enclosed tanks or other enclosed containers. If the liquid composition contains a cyclopropene compound that is volatile, the headspace in the enclosed container could accumulate a high concentration of volatile organic compound, which could create a hazardous situation.

There are also drawbacks to applying gaseous compositions to crop plants in a field. When used in an open field, a gaseous composition will diffuse into the atmosphere and may have little or no effect on the rice plants.

Rice is the seed of the monocot plants of the genus Oryza. The term “rice” herein is used to mean either the rice seed that is harvested or the rice plant on which the seed grows or will grow. Two major rice species under cultivation include Oryza saliva L. and Oryza glaberrima Steud. Rice is an important crop plant. It is desired to provide a method of using cyclopropene compound that enhances the growth of rice and/or other plants while avoiding one or more of the drawbacks discussed above.

### SUMMARY OF THE INVENTION

This invention is related to granule formulations of molecular complexes comprising a volatile compound, where no adjuvant/binder is required in such granule formulations. In addition, it is surprising that use of molecular sieve destabilizes the granule formulations provided herein, thus no molecular sieve is required. Provided are methods for preparing granule formulations of a molecular complex comprising a volatile compound, and compositions comprising such granule formulations. In addition, methods of treating plant or plant parts using compositions disclosed herein are also provided.

In one aspect, provided is a granule formulation comprising (a) a molecular complex of a volatile compound and a molecular encapsulating agent; and (b) a carrier component having moisture content between 5% and 35%.

In one embodiment, the moisture content is between 7% and 15%; or between 8% and 12%. In another embodiment, the moisture content is at least 10%. In another embodiment, the moisture content is about 10%.

In another embodiment, the carrier component comprises clay. In another embodiment, the carrier component comprises bentonite, limestone, or combinations thereof. In another embodiment, the carrier component comprises sodium bentonite clay. In another embodiment, the granule formulation does not comprise a binder component.

In another embodiment, chemical stability of the molecular complex is improved as compared to a control formulation without the carrier component having moisture content between 5% and 35%. In a further embodiment, the chemical stability of the molecular complex is improved at least two folds. In another embodiment, the chemical stability of the molecular complex is improved between two folds and five folds. In another embodiment, the chemical stability of the molecular complex is improved at room temperature, at 54° C., or both.

In another embodiment, the volatile compound comprises a cyclopropene compound of the formula:

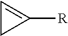

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In one embodiment, R is C₁₋₈ alkyl In another embodiment, R is methyl.

In another embodiment, the volatile compound comprises a cyclopropene compound of the formula:

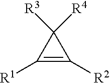

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In another embodiment, the cyclopropane compound comprises 1-methylcyclopropene (1-MCP).

In another embodiment, the granule formulation comprises between 0.1% and 10%; between 0.3% and 3%; or between 0.5% and 1.5% of the 1-MCP. In another embodiment, the molecular encapsulating agent is selected from the group consisting of alpha-cyclodextrin, beta-cyclodextrin, gamma-cyclodextrin, or combinations thereof. In another embodiment, the molecular encapsulating agent comprises alpha-cyclodextrin.

In another aspect, provided is a method for stabilizing a molecular complex of a volatile compound and a molecular encapsulating agent, comprising preparing a granule formulation using a carrier component having moisture content between 5% and 35%.

In one embodiment, the moisture content is between 7% and 15%; or between 8% and 12%. In another embodiment, the moisture content is at least 10%. In another embodiment, the moisture content is about 10%.

In another embodiment, the carrier component comprises clay. In another embodiment, the carrier component comprises bentonite, limestone, or combinations thereof. In another embodiment, the carrier component comprises sodium bentonite clay. In another embodiment, the granule formulation does not comprise a binder component.

In another embodiment, chemical stability of the molecular complex is improved as compared to a control formulation without the carrier component having moisture content between 5% and 35%. In a further embodiment, the chemical stability of the molecular complex is improved at least two folds. In another embodiment, the chemical stability of the molecular complex is improved between two folds and five folds. In another embodiment, the chemical stability of the molecular complex is improved at room temperature, at 54° C., or both.

In another embodiment, the volatile compound comprises a cyclopropane compound of the formula:

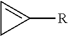

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In one embodiment, R is C₁₋₈ alkyl In another embodiment, R is methyl.

In another embodiment, the volatile compound comprises a cyclopropene compound of the formula:

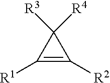

wherein R¹ is a substituted or unsubstituted C₁-C₄ alkyl, C₁-C₄ alkenyl, C₁C₄ alkynyl, C₁-C₄ cylcoalkyl, cylcoalkylalkyl, phenyl, or napthyl group; and R², R³, and R⁴ are hydrogen. In another embodiment, the cyclopropene compound comprises 1-methylcyclopropene (1-MCP).

In another embodiment, the granule formulation comprises between 0.1% and 10%; between 0.3% and 3%; or between 0.5% and 1.5% of the 1-MCP. In another embodiment, the molecular encapsulating agent is selected from the group consisting of alpha-cyclodextrin, beta-cyclodextrin, gamma-cyclodextrin, or combinations thereof. In another embodiment, the molecular encapsulating agent comprises alpha-cyclodextrin.

In another aspect, provided is a method for preparing the granule formulation provided herein. The method comprises using a roller compaction process with a carrier component having moisture content between 5% and 35%.

In one embodiment, no binder is used in the roller compaction process. In another embodiment, no molecular sieve is used in the roller compaction process.

In another aspect, provided is a method of yield increase and/or yield protection of a crop plant comprising applying the granule formulation provided herein to a field cultivating the crop plant, wherein the crop plant is in a reproductive or ripening stage.

In one embodiment, the crop plant is selected from the group consisting of rice plant, maize plant, wheat plant, soybean plant, canola plant, and cotton plant. In another embodiment, the granular formulation comprises 1-methylcyclopropene (1-MCP). In another embodiment, the application rate of 1-MCP is between 10 g active ingredient (a.i.)/hectare and 100 g a.i./hectare; between 20 g a.i./hectare and 70 g a.i./hectare: or between 40 g a.i./hectare and 60 g a.i./hectare. In another embodiment, the application rate of 1-MCP is about 50 g a.i./hectare.

### BRIEF DESCRIPTION OF THE DRAWINGS

FIG. 1 shows a representative roller compaction process used for the granule formulations provided herein.

FIG. 2 shows representative results for moisture influence on degradation (curve average) at 54° C.

FIG. 3 shows representative results for binder influence on degradation (curve average).

FIG. 4 shows representative 1-MCP release rate from formulations containing bentonite, Samples L, M, and N contain 0.1% I-MCP, and Samples O and P contain 0.5% 1-MCP.

FIG. 5 shows representative correlation between the dissolution rate of granules immersed in water, and 1-MCP %

FIG. 6 shows representative data from headspace from 0.5% 1-MCP in sodium bentonite granules.

### DETAILED DESCRIPTION OF THE INVENTION

This invention is based on surprising results that no adjuvant/binder is required for granule formulations of molecular complexes comprising a volatile compound. In addition, surprising that use of molecular sieve destabilizes the granule formulations provided herein, thus no molecular sieve is required. Provided are methods for preparing granule formulations of a molecular complex comprising a volatile compound, and compositions comprising such granule formulations. Also provided are methods of treating plant or plant parts using compositions disclosed herein.

A solid particle is characterized by its particle diameter. If the particle is not spherical, its particle diameter is taken herein to be the diameter of a sphere that has the same volume as the particle.

It is sometimes desirable to formulate product in a dry state to avoid the use of water. Compaction (or granulation) is a size enlargement process that presses powdery material into sheets with or without the use of a binder. The bonding of the material is ensured by the mechanical pressure exerted on the product by the compacting equipment. The sheets are then crushed and screened to produce a granule form of the desired sized product.

As an alternative to wet agglomeration, the compaction/granulation process allows agglomeration of a wider range of materials than other processes and provides a specified and constant product size range. Capacities of compaction/granulation units typically range from 50 Kg/h to 100 T/h.

Roll compaction is a dry granulation method, where many factors need to be considered, controlled and optimized; for example, selection of the carrier and binder, roll pressure, roll speed and the feeding rate of starting materials. These factors determine the product properties (e.g., ribbons formation), as well as the final granule properties. Important product qualities such as the density of ribbons, flowability, compressibility of granules, as well as the strength of the finished granules, are highly dependent on the parameters mentioned above.

Controlling these factors is important to achieve a product of desired quality. A full understanding of the chemical and physical properties of the starting materials and the process parameters is also essential. Numerous articles can be found on compaction processes, However, most agrichemical applications are limited to the formulation of fertilizers.

Unless otherwise stated, the following terms used in this application, including the specification and claims, have the definitions given below. It must be noted that, as used in the specification and the appended claims, the singular forms “a,” “an,” and “the” include plural referents unless the context clearly dictates otherwise. Definition of standard chemistry terms may be found in reference works, including Carey and Sundberg, Advanced Organic Chemistry 4^{th} Ed., Vols. A (2000) and B (2001), Plenum Press, New York, N.Y.

As used herein, the phrase “moiety” refers to a specific segment or functional group of a molecule. Chemical moieties are often recognized chemical entities embedded in or appended to a molecule.

As used herein, the phrase “alkyl” refers to an unsubstituted or substituted, hydrocarbon group and can include straight, branched, cyclic, saturated and/or unsaturated features. Although the alkyl moiety may be an “unsaturated alkyl” moiety, which means that it contains at least one alkene or alkyne moiety, typically, the alkyl moiety is a “saturated alkyl” group, which means that it does not contain any alkene or alkyne moieties, Likewise, although the alkyl moiety may be a cyclic, typically the alkyl moiety is a non-cyclic group. Thus, in some embodiments, “alkyl” refers to an optionally substituted straight-chain, or optionally substituted branched-chain saturated hydrocarbon monoradical having from about one to about thirty carbon atoms in some embodiments, from about one to about fifteen carbon atoms in some embodiments, and from about one to about six carbon atoms in further embodiments. Examples of saturated alkyl radicals include, but are not limited to, methyl, ethyl, n-propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, sec-butyl, t-butyl, n-pentyl, isopentyl, neopentyl, and n-hexyl, and longer alkyl groups, such as heptyl, and octyl. It should be noted that whenever it appears herein, a numerical range such as “1 to 6” refers to each integer in the given range; e.g., “1 to 6 carbon atoms” or “C₁₋₁₃” or “C₁-C₆” means that the alkyl group may consist of 1 carbon atom, 2 carbon atoms, 3 carbon atoms, 4 carbon atoms, 5 carbon atoms, and/or 6 carbon atoms, although the present definition also covers the occurrence of the term “alkyl” where no numerical range is designated.

As used herein, the phrase “substituted alkyl” refers to an alkyl group, as defined herein, in which one or more (up to about five, preferably up to about three) hydrogen atoms is replaced by a substituent independently selected from the substituent group defined herein.

As used herein, the phrases “substituents” and “substituted” refer to groups which may be used to replace another group on a molecule. Such groups are known to those of skill in the chemical arts and may include, without limitation, one or more of the following independently selected groups, or designated subsets thereof: halogen, —CN, —OH, —NO₂, —N₃, ═O, ═S, ═NH, —SO₂, —NH₂, —COOH, —S(O₂)nitroalkyl, amino, including mono-and di-substituted amino groups, cyanato, isocyanato, thiocyanato, isothiocyanato, guanidinyl, O-carbamyl, N-carbamyl, thiocarbamyl, uryl, isouryl, thiouryl, isothiouryl, mercapto, sulfanyl, sulfinyl, sulfonyl, sulfonamidyl, phosphonyl, phosphatidyl, phosphoramidyl, dialkylamino, diarylamino, diarylalkylamino; and the protected compounds thereof. The protecting groups that may form the protected compounds of the above substituents are known to those of skill in the art and may be found in references such as Greene and Wuts, Protective Groups in Organic Synthesis, 3d Ed., John Wiley & Sons, New York, N.Y. (1999) and Kocienski, Protective Groups, Thieme Verlag, New York, N.Y. (1994) which are incorporated herein by reference in their entirety.

As used herein, the phrase “alkoxy” refers to the group —O-alkyl, where alkyl is as defined herein. In one embodiment, alkoxy groups include, e.g., methoxy, ethoxy, n-propoxy, iso-propoxy, n-butoxy, tert-butoxy, sec-butoxy, n-pentoxy, n-hexoxy, 1,2-dimethylbutoxy, and the like. The alkoxy can be unsubstituted or substituted.

As used herein, the phrases “cyclic” and “membered ring” refer to any cyclic structure, including alicyclic, heterocyclic, aromatic, heteroaromatic and polycyclic fused or non-fused ring systems as described herein. The term “membered” is meant to denote the number of skeletal atoms that constitute the ring. Thus, for example, pyridine, pyran, and pyrimidine are six-membered rings and pyrrole, tetrahydrofuran, and thiophene are five-membered rings.

As used herein, the phrase “aromatic” refers to a cyclic or polycyclic moiety having a conjugated unsaturated (4n+2)π electron system (where n is a positive integer), sometimes referred to as a delocalized π electron system.

As used herein, the phrase “aryl” refers to an optionally substituted, aromatic, cyclic, hydrocarbon monoradical of from six to about twenty ring atoms, preferably from six to about ten carbon atoms and includes fused (or condensed) and non-fused aromatic rings. A fused aromatic ring radical contains from two to four fused rings where the ring of attachment is an aromatic ring, and the other individual rings within the fused ring may be cycloalkyl, cycloalkenyl, cycloalkynyl, heterocycloalkyl, heterocycloalkenyl, heterocycloalkynyl, aromatic, heteroaromatic or any combination thereof. A non-limiting example of a single ring aryl group includes phenyl; a fused ring aryl group includes naphthyl, anthryl, azulenyl; and a non-fused bi-aryl group includes biphenyl.

As used herein, the phrase “substituted aryl” refers to an aryl group, as defined herein, in which one or more (up to about five, preferably up to about three) hydrogen atoms is replaced by a substituent independently selected from the group defined herein, (except as otherwise constrained by the definition for the aryl substituent).

As used herein, the phrase “heteroaryl” refers to an optionally substituted, aromatic, cyclic monoradical containing from about five to about twenty skeletal ring atoms, preferably from five to about ten ring atoms and includes fused (or condensed) and non-fused aromatic rings, and which have one or more (one to ten, preferably about one to about four) ring atoms selected from an atom other than carbon (i.e., a heteroatom) such as, for example, oxygen, nitrogen, sulfur, selenium, phosphorus or combinations thereof. The term heteroaryl includes optionally substituted fused and non-fused heteroaryl radicals having at least one heteroatom. A fused heteroaryl radical may contain from two to four fused rings where the ring of attachment is a heteroaromatic ring and the other individual rings within the fused ring system may be alicyclic, heterocyclic, aromatic, heteroaromatic or any combination thereof. The term heteroaryl also includes fused and non-fused heteroaryls having from five to about twelve skeletal ring atoms, as well as those having from five to about ten skeletal ring atoms. Examples of heteroaryl groups include, but are not limited to, acridinyl, benzo[1,3]dioxole, benzimidazolyl, benzindazolyl, benzoisooxazolyl, benzokisazolyl, benzofuranyl, benzofurazanyl, benzopyranyl, benzothiadiazolyl, benzothiazolyl, benzo[b]thienyl, benzothiophenyl, benzothiopyranyl, benzotriazolyl, benzoxazolyl, carbazolyl, carbolinyl, chromenyl, cinnolinyl, furanyl, furazanyl, furopyridinyl, furyl, imidazolyl, indazolyl, indolyl, indolidinyl, indolizinyl, isobenzofuranyl, isoindolyl, isoxazolyl, isoquinolinyl, isothiazolyl, naphthylidinyl, naphthyridinyl, oxadiazolyl, oxazolyl, phenoxazinyl, phenothiazinyl, phenazinyl, phenoxathiynyl, thianthrenyl, phenathridinyl, phenathrolinyl, phthalazinyl, pteridinyl, purinyl, puteridinyl, pyrazyl, pyrazolyl, pyridyl, pyridinyl, pyridazinyl, pyrazinyl, pyrimidinyl, pyrimidyl, pyrrolyl, quinazolinyl, quinoxalinyl, tetrazolyl thiadiazolyl, thiazolyl, thienyl, triazinyl, (1,2,3,)-and (1,2,4)-triazolyl and the like, and their oxides where appropriate, such as for example pyridyl-N-oxide.

As used herein, the phrase “substituted heteroaryl” refers to a heteroaryl group, as defined herein, in which one or more (up to about five, preferably up to about three) hydrogen atoms is replaced by a substituent independently selected from the group defined herein.

As used herein, the phrase “leaving group” refers to a group with the meaning conventionally associated with it in synthetic organic chemistry, i.e., an atom or group displaceable under substitution reaction conditions. Examples of leaving groups include, but are not limited to, halogen, alkane-or arylenesulfonyloxy, such as methanesulfonyloxy, ethanesulfonyloxy, thiomethyl, benzenesulfonyloxy, tosyloxy, and thienyloxy, dihalophosphinoyloxy, optionally substituted benzyloxy, isopropyloxy, acyloxy, and the like. In some embodiments, a leaving group can be HC(O)—COOH or RC(O)—COON, wherein R is a C₁-C₆ alkyl or substituted C₁-C₆ alkyl.

The compounds of the invention as described herein may be synthesized using standard synthetic techniques known to those of skill in the art or using methods known in the art in combination with methods described herein. The starting materials used for the synthesis of the compounds of the invention as described herein, can be obtained from commercial sources, such as Aldrich Chemical Co. (Milwaukee, Wis.), Sigma Chemical Co. (St. Louis, Mo.), or the starting materials can be synthesized. The compounds described herein, and other related compounds having different substituents can be synthesized using techniques and materials known to those of skill in the art, such as described, for example, in March, Advanced Organic Chemistry 4^{th} Ed. (1992) John Wiley & Sons, New York, N.Y.; Carey and Sundberg, Advanced Organic Chemistry 4^{th} Ed., Vols. A (2000) and B (2001) Plenum Press, New York, N.Y. and Greene and Wuts, Protective Groups in Organic Synthesis, 3rd Ed. (1999) John Wiley & Sons, New York, N.Y., (all of which are incorporated by reference in their entirety). General methods for the preparation of compound as disclosed herein may be derived from known reactions in the field, and the reactions may be modified by the use of appropriate reagents and conditions, as would be recognized by the skilled person, for the introduction of the various moieties found in the formulae as provided herein. For example, the compounds described herein can be modified using various electrophiles or nucleophiles to form new functional groups or substituents.

The practice of the present invention involves the use of one or more cyclopropene compound. As used herein, a cyclopropene compound is any compound with the formula

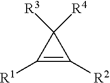

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6.Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R₃, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cycloproplene compound through an intervening oxy group, amino group, carbonyl group, or sulfonyl group; examples of such R₁, R₂, R₃, and R⁴ groups are heterocyclyloxy, heterocyclylcarbonyl, diheterocyclylamino, and diheterocyelylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsiyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl, In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In another embodiment, the cyclopropene compound is of the formula:

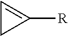

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In one embodiment, R is C₁₋₈ alkyl. In another embodiment, R is methyl.

In another embodiment, the cyclopropene compound is of the formula:

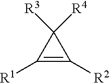

wherein R¹ is a substituted or unsubstituted C₁-C₄ alkyl, C₁-C₄ alkenyl, C₁-C₄ alkynyl. C₁-C₄ cylcoalkyl, cylcoalkylalkyl, phenyl, or napthyl group; and R², R³, and R⁴ are hydrogen. In another embodiment, the cyclopropene comprises 1-methylcyclopropene (1-MCP).

Preferred are embodiments in which a cyclopropene compound is used that has boiling point at one atmosphere pressure of 50° C. or lower; more preferred 25° C. or lower; more preferred 15° C. or lower. Independently, embodiments are preferred in which a cyclopropene compound is used that has boiling point at one atmosphere pressure of −100° C., or higher; more preferred −50° C. or higher; more preferred −25° C. or higher; more preferred 0° C. or higher.

The composition of the present invention includes at least one molecular encapsulating agent that encapsulates one or more cyclopropene compound or a portion of one or more cyclopropene compound. A molecular complex that contains a cyclopropene compound molecule or a portion of a cyclopropene compound molecule encapsulated in a molecule of a molecular encapsulating agent is known herein as a “cyclopropene compound complex.”

In preferred embodiments, at least one cyclopropene compound complex is present that is an inclusion complex. In such an inclusion complex, the molecular encapsulating agent forms a cavity, and the cyclopropene compound or a portion of the cyclopropene compound is located within that cavity.

Preferably, in such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene, compound molecule or portion thereof to remain for substantial amounts of time within the cavity of the molecular encapsulating agent.

The amount of molecular encapsulating agent can usefully be characterized by the ratio of moles of molecular encapsulating agent to moles of cyclopropene compound. In preferred embodiments, the ratio of moles of molecular encapsulating agent to moles of cyclopropene compound is 0.1 or larger; more preferably 0.2 or larger; more preferably 0.5 or larger; more preferably 0.9 or larger. Independently, in preferred embodiments, the ratio of moles of molecular encapsulating agent to moles of cyclopropene compound is 10 or lower; more preferably 5 or lower; more preferably 2 or lower; more preferably 1.5 or lower.

Suitable molecular encapsulating agents include, for example, organic and inorganic molecular encapsulating agents. Preferred are organic molecular encapsulating agents, which include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In preferred embodiments, the encapsulating agent is alpha-cyclodextrin, beta-cyclodextrin, gamma-cyclodextrin, or a mixture thereof. In more preferred embodiments of the invention, alpha-cyclodextrin is used.

The practice of the present invention involves the use of a granular composition. A granular composition is a composition that exists as solid particles under a pressure of 1 atmosphere and at all temperatures from 5° C. to 40° C. A granular composition is a collection of solid particles in which 90% or more of the weight of the collection resides in particles that have particle diameter of 1 micrometer or larger and in which 90% or more of the weight of the collection resides in particles that have particle diameter of 5 centimeter or smaller. Preferred are compositions in which 90% or more of the weight of the collection resides in particles that have particle diameter of 10 micrometer or larger. Also preferred are compositions in which 90% or more of the weight of the collection resides in particles that have particle diameter of 1 centimeter or smaller.

In another aspect of the present invention, there is provided a method of improving the cultivation of rice in a paddy comprising adding a granular composition to the water in said paddy, wherein said granular composition comprises one or more cyclopropene compound encapsulated in a molecular encapsulating agent.

Preferred granular compositions contain 0.02% or more of cyclopropene compound, by weight based on the weight of the granular composition. More preferred granular compositions contain cyclopropene compound in the amount, by weight based on the weight of the granular composition, of 0.05% or more; more preferred is 0.09% or more. Preferred granular compositions contain 5% or less of cyclopropene compound, by weight based on the weight of the granular composition. More preferred granular compositions contain cyclopropene compound in the amount, by weight based on the weight of the granular composition, of 5% or less; 3% or less; or 1% or less.

In addition to cyclopropene compound complex, the particles of the granular composition may contain any material (called “inert” material) that allows the particle to remain solid and that will not inhibit the function of the cyclopropene compound. Suitable materials for inclusion in the granular composition include, for example, sand (for example, feldspar sand), clay (for example, montmorillonite or attapulgite), coal dust, chipped brick, cellulosic fibers or other cellulosic materials, polymers, ground corn cobs, fertilizer, or mixtures thereof. Particles of the granular composition may optionally be coated, for example with polymer, graphite, wax, or a combination thereof.

Rice is often grown in a paddy. A paddy is a field that is flooded for some or all of the plant's growth cycle. Rice may be planted in the paddy prior to flooding the paddy, and in some of such cases the rice may grow to become seedlings before the paddy is flooded. Alternatively, the rice may be planted somewhere other than the paddy and then transplanted as seedlings into the paddy before the paddy is flooded. Often, after seedlings are established in the non-flooded paddy (either by growth from seeds or by transplantation), the paddy is then flooded. In many cases, the paddy remains flooded until shortly before harvest. Sometimes the paddy is drained for one or more short period during the growth cycle of the plants. When the paddy is flooded, the depth of the water is preferably between 20 mm and 100 mm. In preferred embodiments, the paddy is flooded for more than half of the time from transplantation of seedlings until harvest.

The rice that is used in the practice of the present invention may be any species of the genus Oryza. Preferred is Oryza sativa L.

In the practice of the present invention, granular composition is added to the water of the paddy one or more times during the growth cycle of the plants. The addition of the granular composition may be made during any time from transplantation of seedlings until harvest. The growth stages of rice may be described by reference to the BBCH scale for rice (published by the Federal Biological Research Centre for Agriculture and Forestry, Berlin and Braunschweig, Germany), which may be viewed, for example, at world wide web .jki.bund.de/fileadmin/dam_uploads/_veroeff/bbch-BBCH-Skala_englisch.pdf. The BBCH scale provides a code number for each step in the growth cycle of rice, front code 00 (dry seed [caryopsis]) to 99 (harvested product).

It is preferred to treat the rice (i.e., to add the granular composition of the present invention to the water in the paddy) during one or more of the following growth stages: Panicle Development (BBCH codes 30-32); Boot (BBCH codes 40-45); Early Heading (BBCH codes 51-54); Post Anthesis (BBCH codes 65-70). In one embodiment, treatment provided is performed during boot. In another embodiment, treatment provided is perfromed during mid-boot (BBCH code 43).

It is preferred to treat rice that is exposed to high night time temperature or high day time temperature. The treatment may take place before, during, or after the exposure to high temperatures. It is preferred to treat rice prior to exposure to high temperature. This can be accomplished by identifying rice that is expected to be exposed to high temperature, either because it is being grown in a location that often experiences high temperature or because of a specific local weather forecast.

High night temperature occurs during a night in which the lowest temperature during that night is 23° C. or higher. It is preferred to treat rice that experiences one or more night during which the lowest temperature is 23° C. or higher; more preferred is to treat rice that experiences one or more night during which the lowest temperature is 25° C. or higher. High day temperature occurs during a day in which the high temperature during that day is 32° C. or higher. It is preferred to treat rice that experiences one or more days during which the highest temperature exceeds 32° C. or higher; more preferred is to treat rice that experiences one or more days during which the highest temperature is 34° C. or higher.

One useful way to characterize the amount of cyclopropene compound that is used is to state the grams of cyclopropene compound (the active ingredient as “ai” or “a.i.”) that is applied per unit of area. This amount is reported as grams of ai per hectare (g/ha).

Preferred embodiments employ cyclopropene compound at a rate of 1 g/ha or higher; more preferred is 2 g/ha or higher; more preferred is 5 g/ha or higher. Preferred embodiments employ cyclopropene compound at a rate of 100 g/ha or lower; more preferred is 60 g/ha or lower; more preferred is 40 g/ha or lower.

Another characteristic of treatment methods may include the “distribution fraction” of application of granules. Granules are considered to be distributed over the rice paddy randomly but consistently. That is, granules are considered to be distributed in a way that allows the randomness to be apparent if a small area (for example, 5 cm by 5 cm) is examined and that provides a consistent amount of cyclopropene compound to each large area (0.5 meter by 0.5 meter or larger). By “consistent amount” is meant that over the entire rice paddy, if each square sized 0.5 meter by 0.5 meter were examined and the amount of cyclopropene compound were measured, the standard deviation of the distribution of those amounts would be 20% or less of the mean amount.

“Distribution fraction” is characterized by reference to application of standard granules. As used herein, standard granules have 0.1% cyclopropene compound by weight based on the total weight of the granules. When standard granules are distributed randomly but consistently, the density is said to be 100%. To vary the density, a plot that is larger than 0.25 square meters may be divided into sub-plots that are each 0.5 meter by 0.5 meter. Standard granules may be spread randomly and consistently within some sub-plots, while no granules are spread in the other sub-plots. Then the entire plot is said to be spread at distribution fraction of D %, where D %=100*(number of sub-plots containing granules)/(total number of sub-plots). It is contemplated that varying the density could mimic the effect of using different-size granules or more concentrated granules.

Preferred are embodiments in which distribution fraction is 25% or higher; more preferred is 50% or higher; more preferred is 100% or higher.

As used herein, the phrase “transgene vector” refers to a vector that contains an inserted segment of DNA, the “transgene” that is transcribed into mRNA or replicated as RNA within a host cell. The phrase “transgene” refers not only to that portion of inserted DNA that is converted into RNA, but also those portions of the vector that are necessary for the transcription or replication of the RNA. A transgene typically comprises a gene-of-interest but needs not necessarily comprise a polynucleotide sequence that contains an open reading frame capable of producing a protein.

Plants, or plant parts may be treated in the practice of the present invention. One example is treatment of whole plants; another example is treatment of whole plants while they are planted in soil, prior to the harvesting of useful plant parts.

Any plants that provide useful plant parts may be treated in the practice of the present invention. Examples include plants that provide fruits, vegetables, and grains.

As used herein, the phrase “plant” includes dicotyledons plants and monocotyledons plants, Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale. Examples of fruit include banana, pineapple, oranges, grapes, grapefruit, watermelon, melon, apples, peaches, pears, kiwifruit, mango, nectarines, guava, persimmon, avocado, lemon, fig, and berries.

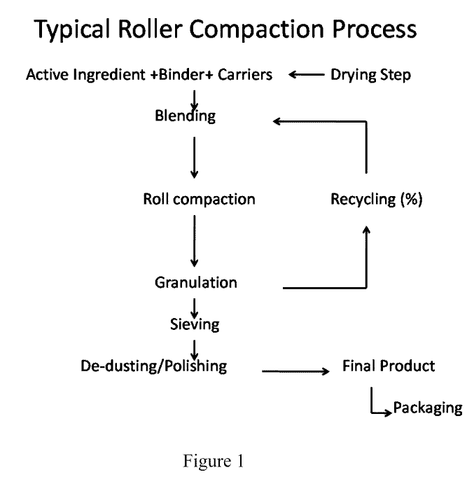

Compaction is a multistep process in which a ribbon of compacted product is formed between wheels applying pressure on the powder to compact. The ribbon is then granulated and screened to the appropriate size. The production of compacted product (for example fertilizers) is often completed by a finishing unit with polishing of granules for improved appearance, reduced amount of residual fines and easier storage. A representative process provided herein is shown in FIG. 1.

In one embodiment, the fine created during the granulations are fully recycled in the system and re-mixed with the original powder blend. This recycling not only reduces waste but is an integral part of the process as it does enhance the compaction ability of the powder and create granules which have more strength.

Provided are suitable binders to increase granule integrity for the granule formulations disclosed. These suitable binders are selected based on having a low moisture content, and being chemically insert toward the active ingredient.

Corn Starch: A dry powdery starch.

Lignosulfonate: A dry powder sodium lignosulfonate from Borregaard LignoTech.

Potassium silicate: Provided under the brand name KASIL® SS. Powder Potassium silicate is from PQ Corporation, Valley Forge, Pa. USA.

Carbowax® 8000: Carbowax 8000 if powder polyethylene glycol with an average molecular weight of 8800. Water content is less than 0.1%. This product is from The Dow Chemical Company.

IGI wax 1236A: IGI 1236A is a fully refined paraffin wax with a typical melting point of 55.6° C. and a specific gravity of 0.91 at 25° C. It is provided in granule form by International Group Inc. (IGI).

Polyset 2016A: Polyset 2016A is a hard, micronized high melting point polyethylene. Softening point is around 117° C. This product was provided by International Group Inc. (IGI).

Feeco Clay: The clay used by Feeco is unaltered Wyoming sodium bentonite clay. It is a product of Black Hills Bentonite, LLC located in WY. Moisture level is 10%, This is the clay we used in all our experiments so far. Unfortunately, we learned that this clay is not available in commercial quantities anymore.

Volclay: Volclay powder is a naturally occurring sodium bentonite with an average particle size less than 200 mesh. Maximum moisture is 12% as shipped. This clay is from American Colloid Company, located in IL.

Best Bond and Prohond 30: Both are activated sodium bentonite. Particle size 80% min passing 200 mesh. Moisture content is 14% maximum. They are products of Volclay Siam (Thailand), a wholly owned subsidiary of AMCOL International Company.

Pelbon: Pelbon is a high quality calcium bentonite supplied as a 150 mesh powder. Maximum moisture level is 15%. This clay is from American Colloid Company.

Gypsum FGD: FGD Gypsum is a synthetic calcium sulfate (CASO₄.H₂O) product derived from flue gas desulfurization (FGD) systems at electric power plants. This product is shipped wet. It is a product from Headwaters Resources located in West Chester, Pa.

CaSO₄.H₂O: Calcium sulfate (Gypsum) can have different degrees of hydration. It is extensively used in dry walls and plaster. The anhydride is a strong desiccant.

KCl: Potassium chloride is also known as muriate of potash. It is a very common fertilizer. This potash with no iron addition is also called white potash.

K₂SO₄: Potassium sulfate is also known as sulfate of potash. The principal use of potassium sulfate is as a fertilizer. K₂SO₄ does not contain chloride, which can be harmful to some crops.

NaCl: sodium chloride is the main component of sea salt and table salt.

B200: B200 is an unmodified corn starch from yellow corn which has been dried on a belt dryer. It contains up to 11% moisture. This is a product from Grain Processing Company (GPC), located in Muscatine, Iowa.

Spress B20: Spress is a pre-gelatinized corn starch for direct compression tablets. Maxinium moisture level is 14%. This is a product from GPC.

Pure-Dent B810: Pure-Dent is corn starch used as multifunctional excipient providing binding, carrying, lubricating and disintegrating properties for tablets. Maximum moisture level is 15%. This is a product from GPC.

Compaction Process: compaction (or granulation) is a size enlargement process that presses powdery material into sheets with or without the use of a binder. The bonding of the material is ensured by the mechanical pressure exerted on the product by the compacting equipment. The sheets are then crushed and screened to produce a granular form of the desired sized product. The compaction/granulation process enables agglomeration of a wider range of materials than other processes (for example wet agglomeration) and provides a specified and constant product size range. Capacities of compaction/granulation units typically range from 50 Kg/h to 100 T/h. Advantages of compaction include reduced volume, stabilized mixtures during handling, elimination of dust problems, controlled hardness, recycle of fines, stability for moisture and/or heat-sensitive compounds.

Roll compaction is a dry granulation method with many factors to be considered, controlled and/or optimized; for example, selection of carrier, selection of dry binder, roll pressure, roll speed, and feeding rate of starting materials. These factors can determine various properties (e.g., ribbons formation, etc.) of the final granule products. Thus, important product qualities such as the density of ribbons, flowability, compressibility of granules, as well as the strength of the finished granules, are highly dependent on these factors.

Compaction is a multistep process in which a ribbon of compacted product is formed between wheels applying pressure on the powder to compact. The ribbon is then granulated and screened to the appropriate size. The production of compacted product is often completed by a finishing unit with polishing of granules for improved appearance, reduced amount of residual fines and easier storage. A representative compaction process used is illustrated in FIG. 1.

The entire fines created during the granulations can be recycled in the system and re-mixed with the original powder blend. This recycling not only reduces waste but is an integral part of the process as it does enhance the compaction ability of the powder and create granules which have more strength.

Raw material carriers are dried overnight in an oven in shallow pans. Temperature in the compaction process used are between 40° C. and 150° C.; 60° C. and 120° C.; or 80° C. and 100° C. Products obtained are screened to the correct size using regular sieve trays of different sizes. In some embodiment, chemical (inorganic) fertilizers can also be used as carriers.

In another aspect, provided is a method of improving the cultivation of rice in a paddy comprising adding a granular composition to the water in the paddy, wherein the granular composition comprises one or more cyclopropene compound encapsulated in a molecular encapsulating agent. In one embodiment, the amount of the cyclopropene compound is 8 mg per hectare or greater. In another embodiment, the adding the granular composition to the water meets one or both of the following criteria: (a) said adding the granular composition to the water is performed after said rice ban been exposed to one or more night during which the lowest temperature during that night was 20° C. or higher; and/or (b) the adding the granular composition to the water is performed at a time when the rice is expected to be exposed in the future to one or more night during which the lowest temperature during that night will be 20° C. or higher.

In another embodiment, the cyclopropene compound is of the formula:

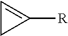

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In one embodiment, R is C₁₋₈ alkyl. In another embodiment, R is methyl.

In another embodiment, the cyclopropene compound is of the formula:

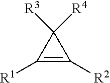

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In another embodiment, the cyclopropene compound comprises 1-methylcyclopropene (1-MCP).

Those skilled in the art would understand certain variation can exist based on the disclosure provided, Thus, the following examples are given for the purpose of illustrating the invention and shall not be construed as being a limitation on the scope of the invention or claims.

### EXAMPLES

Preparation of Granule Formulations—Unless explicitly stated otherwise herein. 90% or more of the weight, based on the weight of the granule formulation, contains particles with particle diameters between 0.1 mm and 10 mm.

Assessment of Improvement to Crop Yield—Each treated plot is compared to an appropriate untreated control plot. The outcome is reported as “DY %” (Delta Yield Percent), which is defined as follows:

DY %=100*[(Y_{T}−Y_{U}/Y_{U}]

where Y_{T}=yield of the treated plot, and where Y_{U}=yield of the untreated plot. For example, DY of 10% means the treated plot has yield that is 10% higher than the untreated plot. Negative Delta Yield means that the treated rice has lower yield than the untreated crop.

### Example 1

### Stability of 1-MCP in the Presence of Carriers

To obtain good field coverage, the granule formulations are increased in bulk by dilution with at least one inert carrier. Carriers are tested using a roller compactor in the presence of 0.1% 1-MCP equivalent of HAIP (High Active Ingredient Particles; a powder of 1-MCP complexed with alpha-cyclodextrin). The blend (before compaction) as well as both the 1^{st} pass and recycled materials are analyzed for chemical stability.

TABLE 1
Active ingredient evolution in the presence of
solid diluents (after compaction)

| | % loss after | % change from RT |
|---|---|---|
| Carriers | one week at RT | after at 54° C. |
| Limestone | 6 | 8 |
| Ammonium Sulfate | 20 | 5 |
| Sodium Bentonite | 2 | 3 |
| Urea | 15 | 100 |
| Ammonium | 50 | 50 |
| Sulfate Granular | | |
| Mono Ammonium | 20 | 20 |
| Sulfate | | |
| Potash (with iron) | 100 | 0 |

All carriers are pre-dried overnight at 65 (or 150° F.) with a residual moisture level close or below 0.5% except for bentonite. The post oven drying moisture in bentonite averages about 2.61%. For clarity, only data from the recycled material are presented in Table 1. Limestone and bentonite appear to be the best carriers in term of chemical stability. However, an adjuvant may need to be added to these powders to increase the granule integrity with these carriers, which is currently poor to very poor.

### Example 2

### Additional Carriers

Three different types of clays are tested in this Example: sodium, calcium and activated bentonite clays.

TABLE 2
Stability and moisture levels for additional carriers

| | | | Change | One | Change | Two | Changes |
|---|---|---|---|---|---|---|---|
| | Moisture | | vs. | week at | vs. | weeks at | vs. |
| Carrier | level % | Ambient | theoretical | 54° C. | ambient | 54° C. | ambient |
| Regular | 8.4 | 0.4234 | −5.92% | 0.4179 | −1.30% | 0.4192 | −0.99% |
| Volclay | | | | | | | |
| Volclay | 0.66 | 0.4371 | −2.88% | 0.4325 | −1.04% | 0.4175 | −4.48% |
| dried at | | | | | | | |
| 120° C. | | | | | | | |
| Calcinated | 0.09 | 0.4469 | −0.68% | 0.4.48 | −9.42% | 0.1768 | −60.44% |
| Gypsum | | | | | | | |
| CaSO₄ | 0.37 | 0.4534 | 0.75% | 0.4443 | −2.01% | 0.3007 | −33.68% |
| KCL | 0.14 | 0.3298 | −26.71% | 0.3016 | −8.55% | 0.3200 | −2.97% |
| K₂SO₄ | 0.22 | 0.3949 | −12.24% | 0.0618 | −84.35% | N.A. | N.A. |
| NaCl (1) | 0.16 | 0.2647 | −41.18% | 0.2598 | −1.85% | N.A. | N.A. |
| NaCl (2) | 0.04 | 0.4542 | 0.93% | 0.3775 | −16.88% | N.A. | N.A. |
| B200 | 11.04 | 0.4325 | −3.89% | 0.4351 | 0.60% | 0.3709 | −14.24% |
| Pure-Dent | 9.16 | 0.4333 | −3.71% | 0.4456 | 2.84% | 0.3667 | −15.37% |
| B810 | | | | | | | |
| Spress | 9.11 | 0.4171 | −7.31% | 0.4108 | −1.51% | 0.3366 | −19.30% |
| B820 | | | | | | | |

Note:
NaCl (1) contains cotnmercial table salt; NaCl (2) purchased from Aldrich.

All clays have an initial relatively high level of moisture (ranging from 7% to 13%). Gypsum is tested at different hydration levels: calcinated (dried at 105° C.) and as an anhydride (from Aldrich). Gypsum FGD is dried overnight at 120° C. Moisture levels are reported in Table 2 below. All the salts show very low moisture levels (<1%). Corn starch on the other hand has a relatively high level of moisture (around 10%).

The results are unexpected and surprising where drying the clay does not increase stability because HAIP is known to be sensitive to water moisture. The results show that compacted products containing clays with certain moisture contents are more stable that product containing dried clays. However, some carriers, for example, calcinated gypsum and its anhydride form, can induce a severe degradation of HAIP regardless of their moisture contents. In addition, the results show that all dried salts (moisture levels in these dried salts are very low) induce significant degradation of HAIP.

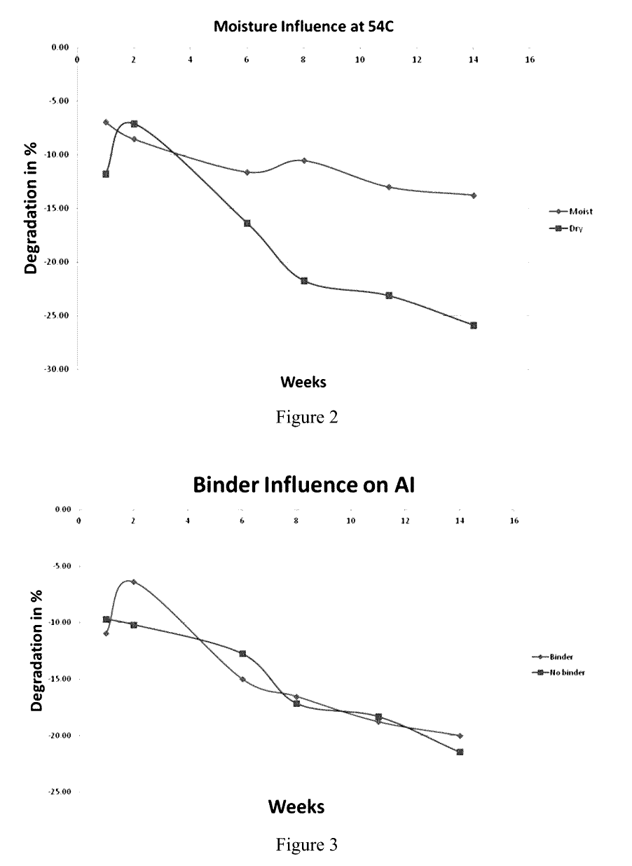

In order to confirm the effect of moisture on stability, results of a long term study are shown in FIG. 2. The results confirm the surprising finding that clays with certain moisture content can be beneficial to the chemical stability of the granules.

Another experiment shows that use of an inert binder has no impact on the increase stability due to moisture content of clays. Stability data from samples with and without cornstarch binder are shown in FIG. 3.

### Example 3

### Release Rate

Approximately 600 mg of a sample containing 0.1% 1-MCP and 120 mg of a sample containing 0.5% 1-MCP are added to a 250 ml glass bottle. Next, 5 ml of Milli Q water is added and the bottle capped. The bottles are swirled slightly to wet the sample and start the release. Sampling is carried out every hour for 4 hours without further shaking or swirling the sample. After twenty-four hours the sample is swirled for 30 minutes on the rotator to release any remaining 1-MCP gas and then analyzed again.

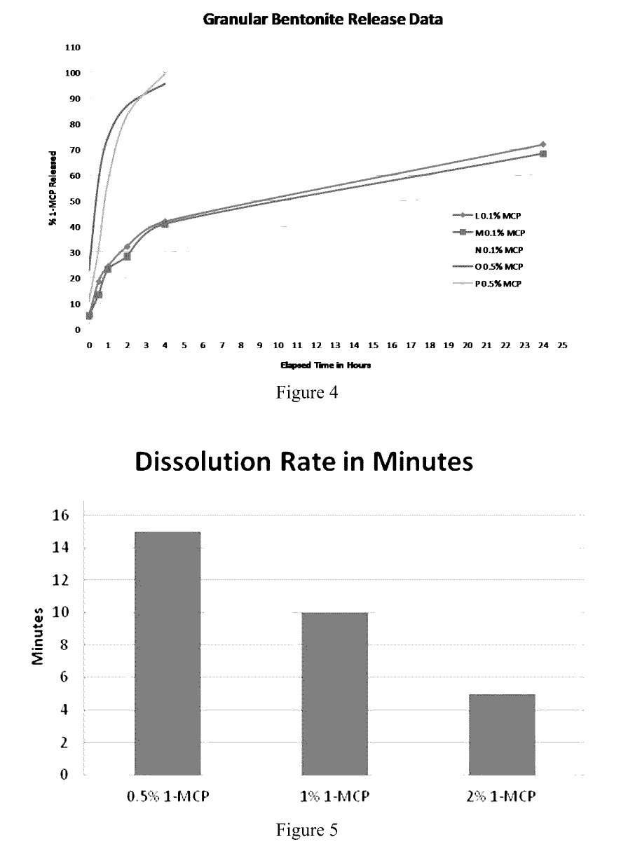

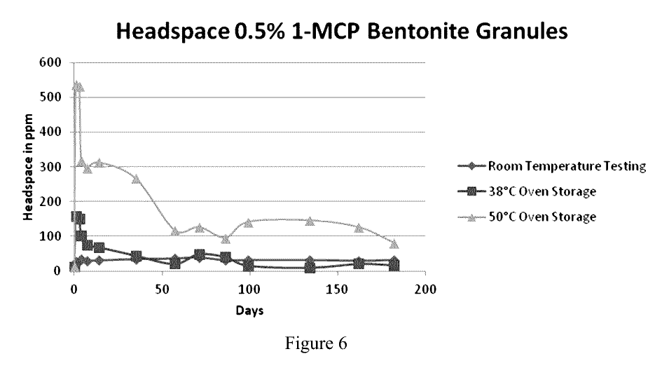

Results are shown in FIG. 4, where bentonite samples containing 0.5% 1-MCP (Samples O and P) induce release of 1-MCP gas much faster than the samples having only 0.1% 1-MCP (Samples L, M, and N). Water penetration happens by swelling the clay upon contact. Bentonite sodium clay can swell 8 to 10 times its weight when wetted. The data suggest that the samples with more clay and less 1-MCP have a slower release rate, In the 0.5% 1-MCP sample, HAIP is much quicker in contact with water and as the HAIP dissolves, more water penetrates inside the granule and in turn channels are created for the gas to escape

Another experiment shows the dissolution rate of granules immersed in water, can be correlated to 1-MCP %. The results are shown in FIG. 5.

### Example 4

### Bentonite and Limestone Granule Formulations

Two concentrations of granules are produced (0.1% 1-MCP and 0.5% 1-MCP) using a modified roller compaction process.

TABLE 3
Active ingredient (HAIP) evolution in the
present of carrier (after compaction)

| | % loss | % change from |
|---|---|---|
| | after one | RT after two weeks |
| Carriers | week at RT | at 54° C. |
| Limestone | 6 | 8 |
| Ammonium Sulfate | 20 | 5 |
| Sodium Bentonite | 2 | 3 |
| Urea | 15 | 100 |
| Ammonium | 50 | 50 |
| Sulfate Granular | | |
| Mono Ammonium | 20 | 20 |
| Sulfate | | |
| Potash (with iron) | 100 | N.A. |

The advantage of compaction is that no liquid binder is used an can be easily adapted for large scale production.

TABLE 4
Moisture levels (in %) in final products

| | | | Binder | | Data set | Data set | |
|---|---|---|---|---|---|---|---|
| Sample# | Carrier | Binder | Concentration | HAIP | 1 | 2 | Mean |
| 5-A | Limestone | Lignosulfonate | 5% | 0.1% | 1.20 | 1.11 | 1.16 |
| 5-B | Limestone | Potassium | 5% | 0.1% | 0.38 | 0.46 | 0.42 |
| | | Silicate | | | | | |
| 5-C | Limestone | Carbowax 8000 | 5% | 0.1% | 0.53 | 0.35 | 0.44 |
| 5-D | Limestone | Carbowax 8001 | 15% | 0.1% | 0.94 | 0.76 | 0.85 |
| 5-E | Limestone | IGI wax 1236A | 15% | 0.1% | 0.96 | 0.65 | 0.81 |
| 5-F | Limestone | Polyset 2016A | 15% | 0.1% | 0.64 | 0.46 | 0.55 |
| 5-G | Limestone | IGI wax 1236A + | 5% | 0.1% | 0.65 | 0.45 | 0.55 |
| | | 2% ligno | | | | | |
| 5-H | Limestone | Polyset 2016A + | 15% | 0.5% | 0.67 | 0.70 | 0.69 |
| | | 2% ligno | | | | | |
| 5-I | Bentonite | Carbowax 8000 | 15% | 0.1% | 1.60 | 1.32 | 1.46 |
| 5-J | Bentonite | Carbowax 8000 | 5% | 0.1% | 3.51 | 3.26 | 3.39 |
| 5-K | Bentonite | Carbowax 8001 | 5% | 0.5% | 3.09 | 3.57 | 3.33 |
| 5-L | Bentonite | IGI wax 1236A | 5% | 0.1% | 2.98 | 3.12 | 3.05 |
| 5-M | Bentonite | IGI wax 1236A | 15% | 0.1% | 2.03 | 2.00 | 2.02 |
| 5-N | Bentonite | Polyset 2016A | 5% | 0.1% | 1.71 | 1.86 | 1.79 |
| 5-O | Bentonite | Polyset 2016A | 5% | 0.5% | 1.77 | 2.30 | 2.04 |
| 5-P | Bentonite | Carbowax 8000 | 15% | 0.5% | 1.83 | 1.63 | 1.73 |

In addition, several carriers and dry binders are tested for chemical compatibility/stability with HAIP and for granule integrity (in particular crushing compression force and attrition resistance).

Bentonite and limestone show the best overall chemical stability and granule strength. These granules show only minimal degradation when chemical stability is tested at 54° C. for two weeks or longer. Addition of molecular sieves to the formulation after compaction surprisingly does not help the chemical stability but unexpectedly is detrimental to the granular strength. Results are shown in Table 3.

When fully immersed in water, the high concentration bentonite granules (0.5% 1-MCP) release their active ingredient (1-MCP) within four (4) hours without agitation. The lower concentration bentonite granules (0.1% 1-MCP) release much slower over a period of twenty four hours (one day) without agitation. Data for post compression moisture in % for granules formulations of limestone and bentonite are shown in Table 4.

### Example 5

### Additional Bentonite and Limestone Granule Formulations

Moisture content of bentonite and limestone appears important for stability of granule formulations.

TABLE 5
Moisture levels (in %) in compacted formulations

| Sample # | Carrier | % 1-MCP | Binder | Data set 1 | Data set 2 | Mean |
|---|---|---|---|---|---|---|
| Batch B1 | Bentonite | 0.1% | 5% Polyset 2016A | 0.53 | 0.51 | 0.52 |
| Batch B2 | Bentonite | 0.1% | 5% Polyset 2016A | 0.68 | 0.67 | 0.68 |
| Batch B3 | Bentonite | 0.5% | 5% Polyset 2016A | 0.65 | 0.73 | 0.69 |
| Batch B4 | Bentonite | 0.5% | 5% Polyset 2016A | 0.78 | 0.74 | 0.76 |
| Batch L2 | Limestone | 0.1% | 15% Polyset 2016A | 0.20 | 0.19 | 0.20 |
| Batch L3 | Limestone | 0.1% | 15% Polyset 2016A | 0.27 | 0.20 | 0.24 |
| Batch L4 | Limestone | 0.5% | 15% Polyset 2016A | 0.32 | 0.35 | 0.34 |

| | | | | |
|---|---|---|---|---|
| Bentonite | Powder after heating at 104° C. | 0.62 | 0.81 | 0.72 |
| Limestone | Powder after heating at 104° C. | 0.31 | 0.35 | 0.33 |

Bentonite is dried to less than 1% moisture by heating at 104° C. for twenty-four (24) hours. However, at this low level moisture, bentonite compression becomes not very efficient with or without presence of a binder. Adding molecular sieves has a surprising negative impact on the granule integrity. Physical stabilities of various bentonite and limestone granule formulations are tested and results are shown in Table 5.

Sodium-bentonite and limestone granules are prepared with 5% or 15% of micronized polyethylene binder, respectively. All granules are second pass with 50% recycle fines. Results of compression and attrition data are shown in Table 6 (mean of two sets).

TABLE 6
Compression and attrition data of formulations of this Example

| | | % | Attrition | Compression |
|---|---|---|---|---|
| Sample # | Carrier | 1-MCP | % | (in lb force) |
| Batch B1 | Bentonite | 0.1% | 5.07 | 9.14 |
| Batch B2 | Bentonite | 0.1% | 6.29 | 7.85 |
| Batch B3 | Bentonite | 0.5% | 8.47 | 6.36 |
| Batch B4 | Bentonite | 0.5% | 7.06 | 6.91 |
| Batch L2 | Limestone | 0.1% | 10.30 | 5.27 |
| Batch L3 | Limestone | 0.1% | 7.40 | 5.22 |
| Batch L4 | Limestone | 0.5% | 4.84 | 5.50 |

### Example 6

### Headspace Sample Analysis

100 grams of AGF-B (0.5% 1-MCP granules), batch B-3, is added to a 607 ml bottle with a sampling port.

TABLE 7
Results of headspace
sample analysis (in ppm)
(from 0.5% 1-MCP granules)

| Days | RT | 38° C. | 50° C. |
|---|---|---|---|
| 0 | 13 | 13 | 13 |
| 1 | 27 | 158 | 536 |
| 3 | 30 | 150 | 533 |
| 4 | 33 | 102 | 318 |
| 7 | 30 | 75 | 297 |
| 14 | 31 | 69 | 313 |
| 35 | 35 | 45 | 267 |
| 57 | 37 | 21 | 118 |
| 71 | 40 | 49 | 127 |
| 86 | 31 | 41 | 96 |
| 99 | 32 | 16 | 142 |
| 134 | 32 | 10 | 146 |
| 162 | 30 | 21 | 126 |
| 182 | 32 | 17 | 81 |

Samples are stored at room temperature (RT), 38° C, or 50° for 6 months and sampled periodically. Isobutylene is used as the standard for analysis. Data are shown in Table 7.

Headspace analysis is performed by sampling granules into 250 ml narrow mouth bottles right after compression on the roller compactor. Bottles are approximately ⅓ filled with granules and capped with a gas tight lid having a sampling port. Samples are not re-opened once capped. The headspace analysis can be indicative to simulate how flammable the granule formulation can be after stored in an enclosure or enclosed space.

Even in the worst case scenario (sample kept at 50° C.), the headspace number is low and mostly below 200 ppm. At 38° C. and RT, headspace is mostly below 50 ppm, demonstrating stability of the granule samples tested.

### Example 7

### Long Term Stability Test

HAIP is sieved to remove lumps with a manual sifter. Sieve size is approximately 1 mm or 18 mesh. Sieved HAIP is then blended with Volclay (American Colloid Company, Illinois).

TABLE 8
Ribbon samples from small compactor (roll pressure at 5 Mpa)

| | Sieved | % 1- | | | Roll | Screw | |
|---|---|---|---|---|---|---|---|
| Sample# | HAIP | MCP | Clay | Binder | (RPM) | (RPM | Comments |
| 7-1 | No | 0.5 | Moist | None | 3.1 | 17.1 | White spots in ribbon |
| 7-2 | Yes | 0.5 | Moist | None | 3.1 | 17.1 | Good ribbon formation |
| 7-3 | Yes | 1.0 | Moist | None | 3.0 | 20.5 | Good quality |
| 7-4 | Yes | 1.0 | Moist | None | 3.0 | 20.6 | Good quality |
| 7-5 | Yes | 0.5 | Moist | 5% B820 | 3.0 | 17.2 | Good quality |
| 7-6 | Yes | 1.0 | Moist | 5% B820 | 3.0 | 20.1 | Good quality |
| 7-7 | Yes | 0.5 | Dried | None | 2.9 | 30.0 | Poor forming quality and |
| | | | | | | | poor integrity |
| 7-8 | Yes | 1.0 | Dried | None | 3.0 | 20.0 | Very poor forming |
| | | | | | | | quality |
| 7-9 | Yes | 0.5 | Dried | 5% B820 | 3.0 | 21.5 | Okay forming quality |
| 7-10 | Yes | 1.0 | Dried | 5% B820 | 3.0 | 20.0 | Poor ribbon formation |

A gentle mixing is performed in a half full glass jar rotated for 10 minutes on a Glas-Col tumbler (speed: 40% of full setting). Two concentrations of the blend are made: 0.5% 1-MCP and 1% 1-MCP. Samples prepared in this example are listed in Table 8.

Following the compaction, the ribbons are kept at either room temperature or 54° C. for stability testing for up to approximately six (6) months. Granule formulations of samples 7-3 and 7-4 (1% 1-MCP, moist clay, and no binder) have overall good quality granule formation and chemical stability. After approximately six months, samples 7-3 and 7-4 made with clay containing 10% moisture lose no more than 3% total 1-MCP at room temperature and between 5% and 11% total 1-MCP at 54° C. Other samples with dried clay are less stable, where degradation ranges from 3% to 10% total 1-MCP at room temperature and from 19% to 23% total 1-MCP at 54° C. Most of the degradation appears within the first week of aging. No significant difference is observed between 0.5% 1-MCP and 1.0% 1-MCP.

### Example 8

### Treatment of Rice Plants

Granule formulations of samples 7-3 and 7-4 are used to treat rice plants in open fields. Typical amount of 1-MCP treated range from 10 g active ingredient (a.i.)/hectare (or 4 g a.i./acre) to 100 g a.i./hectare (or 40 g a.i/acre).

TABLE 9
Yield increase with 1-MCP
treatment on rice plants

| Treatment | 1-MCP | Yield | Mean |
|---|---|---|---|
| # | treatment | (kg/ha) | (kg/ha) |
| 8-1 | Yes | 7450 | 7592.5 |
| 8-2 | Yes | 7865 | |
| 8-3 | Yes | 7715 | |
| 8-4 | Yes | 7340 | |
| 8-5 | No | 7256 | 7005.75 |
| 8-6 | No | 7057 | |
| 8-7 | No | 6933 | |
| 8-8 | No | 6777 | |

Optimum phonological stages of the rice plants range from maximum tillering through grain filling (for example at least one of: meiosis, complete open of flower, and grain filling). Typically only a single treatment of 1-MCP is performed before harvest, but multiple treatments of 1-MCP before harvest can also be performed. Treatment(s) of 1-MCP on rice plants show yield increase ranging from 14% to 28%, depending on the amount of 1-MCP and stage of treatment(s). Data of a field trial using single application of 50 g a.i./hectare 1-MCP with sample 7-3 (a granule formulation containing 1% 1-MCP) are shown in Table 9

1-17. (canceled)

18. A method for stabilizing a molecular complex of a volatile compound and a molecular encapsulating agent, the method comprising preparing a granule formulation using a carrier component having a moisture content between 5% and 35%.

19. A method for preparing a granule formulation, the method comprising using a roller compaction process,
wherein the granule formulation comprises
(a) a molecular complex of a volatile compound and a molecular encapsulating agent; and
(b) a carrier component having moisture content between 5% and 35%.

20. The method of claim 19, wherein no binder is used in the granule formulation.

21. The method of claim 19, wherein no molecular sieve is used in the granule formulation.

22. A method of yield increase and/or yield protection of a crop plant comprising applying a granule formulation to a field cultivating the crop plant, wherein the crop plant is in a reproductive or ripening stage,
wherein the granule formulation comprises
(a) a molecular complex of a volatile compound and a molecular encapsulating agent; and
(b) a carrier component having moisture content between 5% and 35%.

23. The method of claim 22, wherein the crop plant is selected from the group consisting of rice plant, maize plant, wheat plant, soybean plant, canola plant, and cotton plant.

24. The method of claim 22, wherein the granule formulation comprises 1-methylcyclopropene (1-MCP).

25. The method of claim 24, wherein the application rate of 1-MCP is between 10 g active ingredient (a.i.)/hectare and 100 g a.i./hectare.

26. The method of claim 18, wherein chemical stability of the molecular complex is improved as compared to a control formulation without the carrier component having moisture content between 5% and 35%.

27. The method of claim 26, wherein the carrier component comprises bentonite, limestone, or combinations thereof.

28. The method of claim 26, wherein the carrier component comprises sodium bentonite clay.

29. The method of claim 26, wherein the chemical stability of the molecular complex is increased at least two folds.

30. The method of claim 19, wherein chemical stability of the molecular complex is improved as compared to a control formulation without the carrier component having moisture content between 5% and 35%.

31. The method of claim 19, wherein the granule formulation comprises 1-MCP.

32. The method of claim 31, wherein the granule formulation comprises between 0.1% and 10% 1-MCP.

33. The method of claim 19, wherein the carrier component comprises bentonite, limestone, or combinations thereof.

34. The method of claim 19, wherein the granule formulation further comprises recycled fines.

35. The method of claim 34, wherein the granule formulation comprises 50% recycled fines.

36. The method of claim 19, wherein the method avoids the use of water.

37. The method of claim 19, wherein the method produces granules having a particle size between 0.1 mm and 10 mm.
